(19) United States
(12) Patent Application Publication
(10) Pub. No.: US 2011/0233198 A1
(43) Pub. Date: Sep. 29, 2011

(54) SUBSTRATE PROCESSING APPARATUS AND SUBSTRATE PROCESSING METHOD

(75) Inventors: Masahisa OKUNO, Toyama (JP); Atsushi UMEKAWA, Toyama (JP)

(73) Assignee: HITACHI KOKUSAI ELECTRIC INC., Tokyo (JP)

(21) Appl. No.: 13/052,512

(22) Filed: Mar. 21, 2011

(30) Foreign Application Priority Data
Mar. 25, 2010 (JP) 2010-069214

(51) Int. Cl. H05B 6/10

(52) U.S. Cl. 219/651

(57) ABSTRACT

A substrate processing apparatus and a substrate processing method capable of supplying uniform electromagnetic wave power and performing uniform heating are provided. The substrate processing apparatus includes a process chamber for processing a wafer, a boat installed in the process chamber to hold the wafer, a gas introduction part installed below the wafer held by the boat for introducing a gas toward a back surface of the wafer, and a waveguide port installed over the wafer held by the boat for introducing an electromagnetic wave.

### CROSS-REFERENCE TO RELATED PATENT APPLICATION

This application claims priority to and the benefit of Japanese Patent Applications No. 2010-069214 filed on Mar. 25, 2010, the disclosure of which is incorporated herein by reference.

### 1. FIELD OF THE INVENTION

The present invention relates to a substrate processing apparatus and a substrate processing method.

### 2. DESCRIPTION OF THE RELATED ART

A substrate processing apparatus heats a wafer using an electromagnetic wave (for example, a fixed frequency microwave or a variable frequency microwave).

The conventional substrate processing apparatus includes a process chamber for introducing the electromagnetic wave to process a wafer, a gas introduction port for introducing a gas into the process chamber, and a gas exhaust port for exhausting the gas from the process chamber. The gas introduction port and the gas exhaust port are installed diagonally in an upper portion of the process chamber.

However, when the gas introduction port and the gas exhaust port are disposed in the upper portion of the process chamber, an anabatic airflow generated due to a heat generated from the wafer heated by the electromagnetic wave collides with the gas introduced from the gas introduction port, resulting in an instability of the airflow over the wafer.

Thus, the gas introduced through the gas introduction port may not spread to an entirety of the process chamber. For example, the introduced gas may stay or may not easily reach a lower side of the process chamber.

As described above, when the airflow in the process chamber becomes unstable, a cooling effect by the introduced gas is degraded.

When the cooling effect by the introduced gas is degraded, a wall surface of the process chamber is heated to a high temperature and a reflective efficiency of the electromagnetic wave of the wall surface of the process chamber is degraded. When an electromagnetic power of the wall surface of the process chamber is degraded, a substantial electromagnetic power in the process chamber is attenuated and a temperature profile of a heat treatment is changed.

In addition, when the temperature is to be adjusted according to an intensity of the electromagnetic power, a power loss or a time loss for a temperature stabilization may occur, causing a non-uniform heating. For example, when the apparatus is used for the purpose of curing and annealing, a film on a surface of the wafer is partially cured due to the non-uniform heating. As the film is cured, a separation of impurities in the substrate cannot be facilitated.

### SUMMARY OF THE INVENTION

It is an object of the present invention to provide a substrate processing apparatus and a substrate processing method capable of uniformly supplying an electromagnetic power to perform a uniform heating.

According to a first embodiment of the present invention, there is provided a substrate processing apparatus including: a process chamber for processing a substrate; a substrate holder installed in the process chamber to hold the substrate; a gas introduction part installed below the substrate held by the substrate holder for introducing a gas toward a back surface of the substrate; and an electromagnetic wave introduction part installed over the substrate held by the substrate holder for introducing an electromagnetic wave.

According to a second embodiment of the present invention, there is provided there is provided a substrate processing method including steps of: loading a substrate into a process chamber and holding the substrate using a substrate holder; introducing a gas into the process chamber from a gas introduction part installed below the substrate held by the substrate holder; exhausting the gas in the process chamber through a gas exhausting part installed over the substrate held by the substrate holder; and introducing an electromagnetic wave into the process chamber. Accordingly, an electromagnetic power can be uniformly supplied to perform a uniform heating.

According to the present invention, a substrate processing apparatus and a substrate processing method capable of uniformly supplying electromagnetic power to perform uniform heating are provided.

### BRIEF DESCRIPTION OF THE DRAWINGS

FIG. 1 is a cross-sectional view of a substrate processing apparatus in accordance with a first embodiment of the present invention.

FIG. 2 is a perspective view of an electromagnetic heating apparatus.

FIG. 3A is a cross-sectional view taken along line A-A of the electromagnetic heating apparatus shown in FIG. 1, and FIG. 3B is a top view of the electromagnetic heating apparatus.

FIG. 4 is a diagram schematically illustrating a flow of an introduced gas in a process chamber.

FIG. 5 is a flow diagram illustrating an operation of the substrate processing apparatus.

FIG. 6 is a cross-sectional view of an electromagnetic heating apparatus in accordance with a second embodiment of the present invention.

### DETAILED DESCRIPTION OF THE PREFERRED EMBODIMENTS

### First Embodiment

A configuration of a substrate processing apparatus 10 in accordance with the first embodiment of the present invention will be described with reference to the accompanying drawings.

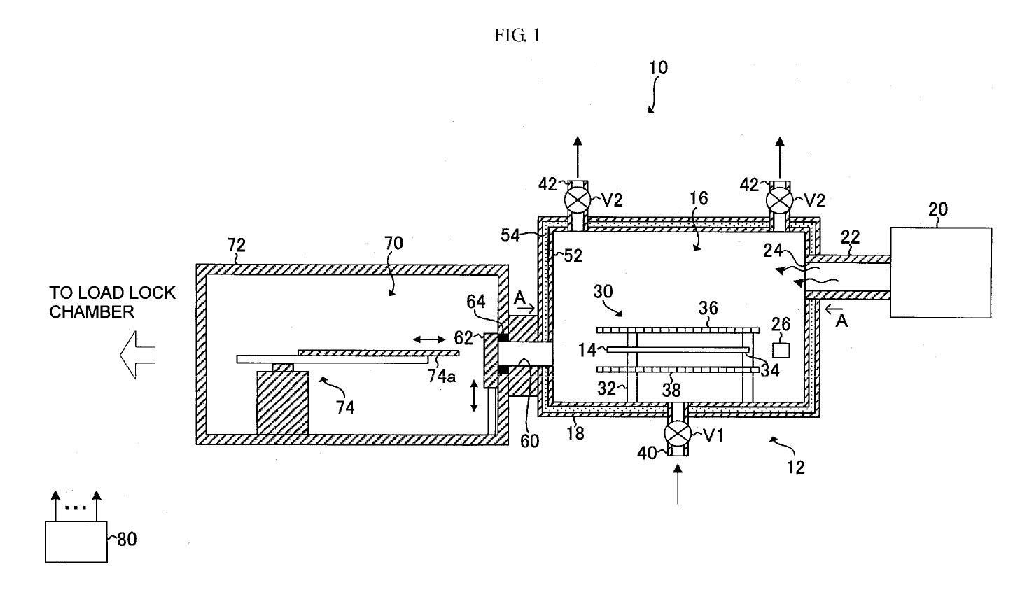

FIG. 1 is a cross-sectional view of the substrate processing apparatus 10 in accordance with the first embodiment of the present invention.

The substrate processing apparatus 10 includes an electromagnetic heating apparatus 12. The electromagnetic heating apparatus 12 includes a process container 18 including a process chamber 16 disposed therein to process a wafer 14 as a substrate, and an electromagnetic wave generating part 20 for generating an electromagnetic wave (for example, a fixed frequency microwave or a variable frequency microwave). The electromagnetic wave generated from the electromagnetic wave generating part 20 is introduced into the process chamber 16 from a waveguide port 24 via a waveguide 22. A temperature detector 26 is installed in the process chamber 16 to detect a temperature of the wafer 14. The temperature detector 26 is electrically connected to a controller 80, which is described later.

The process container 18 is made of a metal material such as an aluminum (Al) and a stainless steel (SUS), to electromagnetically close the process chamber 16.

A microtron, for example, may be used as the electromagnetic wave generating part 20.

A boat 30 is installed in the process chamber 16 as a substrate holder for holding the wafer 14. A plurality of (in this embodiment, three) posts 32 made of, for example, a quartz or a Teflon (registered trademark), are installed on the boat 30. Each of the posts 32 has a placing groove 34 for placing the wafer 14, and ring-shaped reflective plates 36 and 38 are installed at upper and lower positions having the placing grooves 34 therebetween. The reflective plates 36 and 38 reflect the electromagnetic wave.

The boat 30 is installed in a manner that a center of the wafer 14 held therein is substantially in line with a center of the process chamber in a vertical direction.

The waveguide port 24 for supplying the electromagnetic wave into the process chamber 16 is installed over the wafer 14 held by the boat 30. By above-described configuration, a predetermined distance is maintained between the wafer 14 and the waveguide port 24 to suppress a difference in a heating condition of the wafer 14 compared to a case without the above-described configuration. That is, an overheating or an underheating of a portion of the wafer 14 can be prevented without using a reflector (a reflective plate for uniformly irradiating the microwave).

A gas introduction part 40 is installed at a lower portion of the process container 18 to introduce a gas such as a nitrogen (N₂) gas. A valve V1 is installed at the gas introduction part 40. When the valve V1 is opened, the gas is introduced into the process chamber 16 from the gas introduction part 40. The gas introduced from the gas introduction part 40 (hereinafter, referred to as the introduced gas) is used for cooling the wafer 14 or a wall surface 52, which will be described later, or used as a purge gas to purge the gas in the process chamber 16.

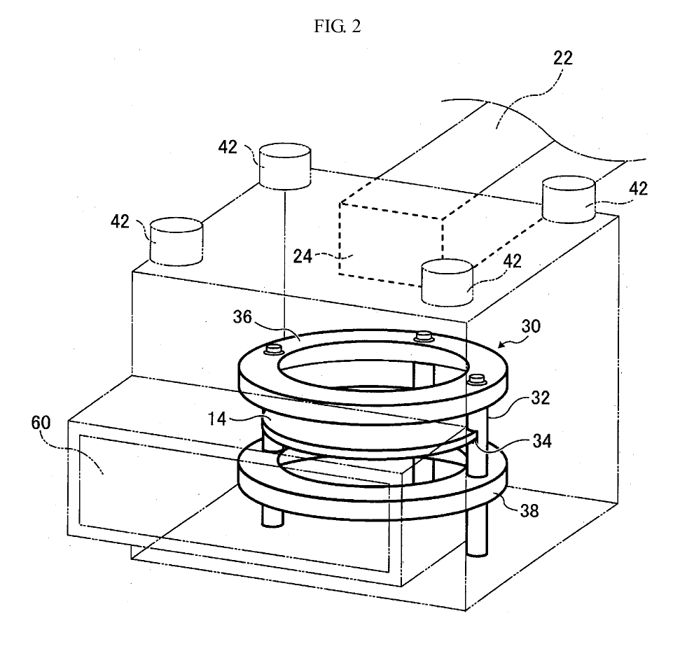

Four gas exhausting parts 42 are installed at an upper portion of the process container 18 to exhaust the introduced gas (see FIG. 2). Valves V2 are installed at each of the four gas exhausting parts 42. When the valves V2 are opened, the gas in the process chamber 16 is exhausted through the gas exhausting parts 42.

A cooling plate 54 is installed on the wall surface 52 of the process container 18 to cool the wall surface 52. Cooling water is supplied into the cooling plate 54 to suppress a temperature of the wall surface 52 from rising due to a radiated heat or a heated gas during the process, for instance. As a result, a reduction in a reflective efficiency of the electromagnetic wave of the wall surface 52 due to the rise of the temperature can be suppressed. As the temperature of the wall surface 52 is uniformly maintained, the reflective efficiency of the electromagnetic wave of the wall surface 52 can be uniformly maintained, and further, the substantial electromagnetic wave power can be stably maintained.

A wafer transfer port 60 is installed on one side surface of the wall surface 52 of the process container 18 to transfer the wafer 14 into/from the process chamber 16. A gate valve 62 is installed at the wafer transfer port 60. When the gate valve 62 is opened, the process chamber 16 is in communication with a transfer chamber (a preliminary chamber) 70. The transfer chamber 70 is disposed in a sealed container 72.

A non-metal gasket (a conductive O-ring) 64 is installed as a sealing member at a contact area between the gate valve 62 and the wafer transfer port 60. Thus, the contact area between the gate valve 62 and the wafer transfer port 60 is sealed, thereby preventing a leakage of the electromagnetic wave from the process chamber 16. In addition, the conductive O-ring 64 reduces a metallic contact between the wafer transfer port 60 and the gate valve 62 to suppress a generation of dusts or a contamination by a metal.

A transfer robot 74 is installed in the transfer chamber 70 to transfer the wafer 14. The transfer robot 74 includes a transfer arm 74a to support the wafer 14 while the wafer 14 is transferred. When the gate valve 62 is opened, the wafer 14 is transferred between the process chamber 16 and the transfer chamber 70 by the transfer robot 74. The wafer 14 transferred into the process chamber 16 is placed in the placing grooves 34.

For example, as a height of the placing part (the placing groove 34) of the wafer 14 in the process chamber 16 is adjusted to a height of the transfer arm 74a, the transfer arm 74a can be horizontally moved to transfer the wafer 14 between the inside of the process chamber 16 and the inside of the transfer chamber 70. That is, the configuration can be simplified without installing a mechanism for lifting the boat 30.

Next, the electromagnetic heating apparatus 12 will be described in detail.

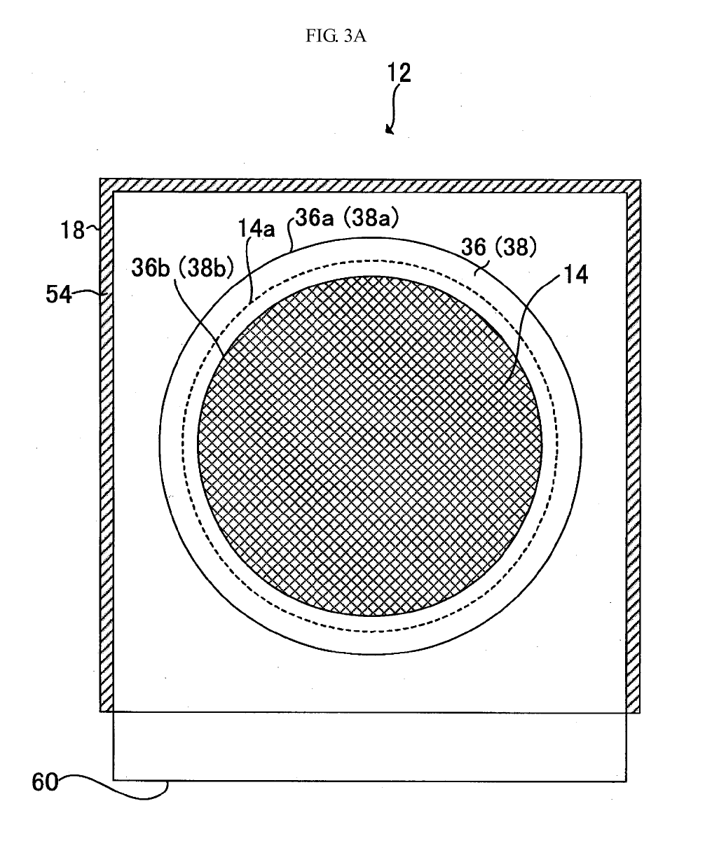

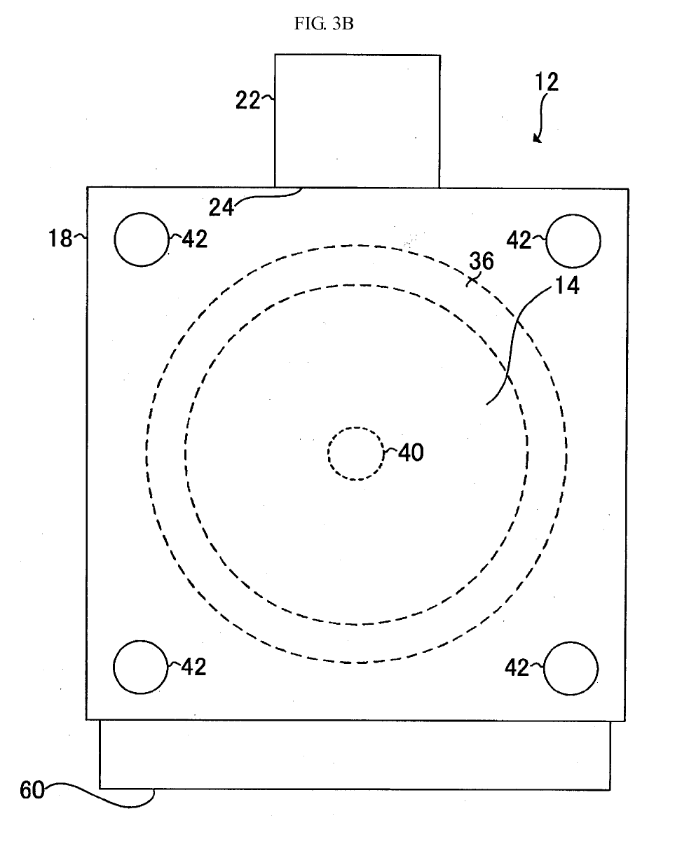

FIG. 2 is a perspective view of the electromagnetic heating apparatus 12. FIG. 3A is a cross-sectional view taken along line A-A (a height between the waveguide port 24 and the boat 30) of the electromagnetic heating apparatus 12 shown in FIG. 1, and FIG. 3B is a top view of the electromagnetic heating apparatus 12.

Since the posts 32 of the boat 30 are made of, for example, the quartz or the Teflon, the electromagnetic wave can pass through. As a result, the electromagnetic wave is more effectively irradiated to an entire surface of the wafer 14 compared to the case without the above-described configuration.

The reflective plates 36 and 38 are made of a material capable of reflecting the electromagnetic wave (for example, a metal), and has an outer diameter larger than an outer diameter of the wafer 14 and an inner diameter smaller than the outer diameter of the wafer 14. That is, as shown in FIG. 3A, outer circumferences 36a and 38a of the reflective plates 36 and 38 are disposed outside an outer circumference 14a of the wafer 14 in a radial direction thereof, and inner circumferences 36b and 38b of the reflective plates 36 and 38 are disposed inside the outer circumference 14a of the wafer 14 in the radial direction. As a result, an edge (the vicinity of the outer circumference 14a) of the wafer 14 placed in the placing groove 34 vertically overlaps the reflective plates 36 and 38.

Here, in the heating by the electromagnetic wave, when a subject to be heated has an edge face or a projection, an electric field generated by an electromagnetic energy is concentrated to the edge face or the projection (an edge face effect), and the subject to be heated may be non-uniformly heated. Therefore, as described in this embodiment, the reflective plates 36 and 38 vertically overlap the edge of the wafer 14 so that the electromagnetic wave are reflected by the reflective plates 36 and 38 to adjust the electromagnetic wave irradiated to the edge of the wafer 14. As a result, an overheating (non-uniform heating) of the edge of the wafer 14 due to the edge face effect of the electromagnetic wave is prevented, thereby uniformly heating the wafer 14.

The reflective plates 36 and 38 are installed to overlap the wafer 14 to a range of 5 to 8 mm from the outer circumference 14a of the wafer 14. That is, a radius of the inner circumferences 36b and 38b of the reflective plates 36 and 38 is smaller than that of the wafer 14 by 5 to 8 mm. When an overlapping portion is smaller than 5 mm, an effect of preventing the non-uniform heating by the edge face effect is reduced. In addition, when the overlapping portion is larger than 8 mm, a heating operation of the wafer 14 is weakened due to an increase in an area of the wafer 14 covered by the reflective plates 36 and 38.

The reflective plates 36 and 38 are disposed in a manner that a distance in vertical direction from the wafer 14 is smaller than 150 mm. When the distance is 150 mm or more, the effect of preventing the non-uniform heating due to the edge face effect is weakened. When the reflective plates 36 and 38 are installed at a position nearest possible without interfering with the transfer of the wafer 14, the non-uniform heating due to the edge face effect can be more effectively prevented compared to a case the reflective plates 36 and 38 are installed farther.

As shown in FIG. 3B, the gas introduction part 40 is installed at about a center of a bottom surface of the process chamber 16, and the gas exhausting parts 42 are installed at four corners of the process chamber 16 having a cuboid shape. In addition, a diffuser may be installed at the gas introduction part 40 to uniformly diffuse the gas.

The gas exhausting parts 42 are installed vertically outside the outer circumference 14a of the wafer 14. Accordingly, dropping of impurities attached to the gas exhausting parts 42 onto the wafer 14 can be prevented.

The substrate processing apparatus 10 includes a controller 80 for controlling operations of the components of the substrate processing apparatus 10. The controller 80 controls the operations of the electromagnetic wave generating part 20, the gate valve 62, the transfer robot 74, and the valves V1 and V2.

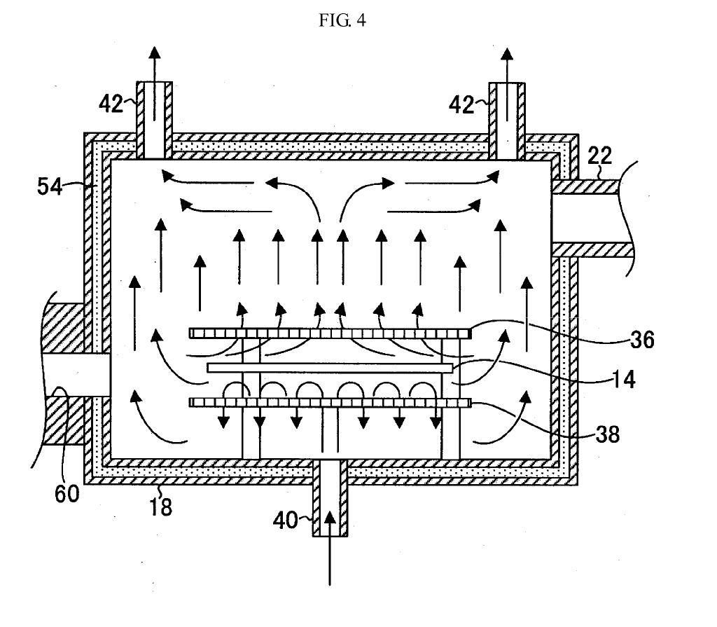

FIG. 4 is a diagram schematically illustrating a flow of the introduced gas in the process chamber 16. The introduced gas is injected toward about a center of a back surface of the wafer 14, and then spreads throughout the process chamber 16. The wafer 14 is cooled by injecting the introduced gas. When the introduced gas is injected toward an inner portion within 10 mm or more from the outer circumference 14a of the wafer 14, the wafer 14 can be more effectively cooled than when the introduced gas is injected toward an outer portion more than 10 mm from the outer circumference 14a of the wafer 14.

Since the introduced gas spread throughout the process chamber 16 is uniformly exhausted at four corners of an upper portion of the process chamber 16, the gas can naturally flow in the process chamber 16 rather than staying at one place. Accordingly, degassing generated from the wafer 14 and a secondarily generated byproduct gas can be smoothly exhausted along with a gas heated in the process chamber 16. Accordingly, an attachment of byproducts to an inner wall of the process chamber 16 is suppressed.

Since the introduced gas flows from a center portion to an outer portion and simultaneously from the lower portion to the upper portion of the process chamber 16, both the wafer 14 and the process chamber 16 can be uniformly cooled. In addition, the gas in the process chamber 16 can be effectively exhausted compared to the case without the above-described configuration,

As described above, the electromagnetic heating apparatus 12 of the substrate processing apparatus 10 in accordance with the first embodiment of the present invention is configured to effectively heat the inside of the process chamber 16. As a result, the reduction in the reflective efficiency of the electromagnetic wave due to a high temperature of the process chamber 16 can be prevented.

Accordingly, since a substantial attenuation of the electromagnetic wave power in the process chamber 16 is suppressed, the process chamber 16 may be stably heated by continuously supplying a uniform electromagnetic wave power. In particular, when the apparatus is used for the purpose of curing or annealing, a uniform separation of impurities may be performed by the uniform and stable heating.

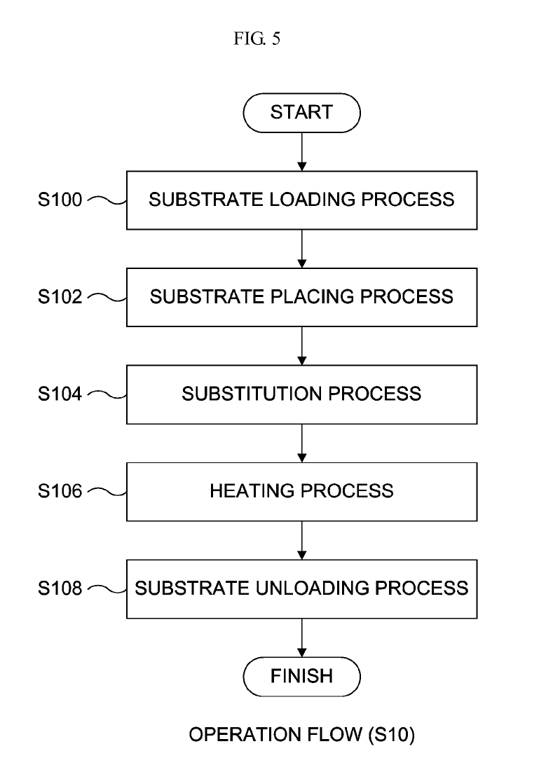

Next, an operation of the substrate processing apparatus 10 will be described. FIG. 5 is a flow diagram illustrating the operation S10 of the substrate processing apparatus 10.

In step 100 (S100), the wafer 14 is loaded into the process chamber 16. The gate valve 62 is opened such that the process chamber 16 is in communication with the transfer chamber 70. Thereafter, the wafer 14 is loaded into the process chamber 16 from the transfer chamber 70 by the transfer robot 74 with the transfer arm 74a supporting the wafer 14 to be processed (substrate loading process).

In step 102 (S102), the wafer 14 is held by the boat 30. The wafer 14 loaded into the process chamber 16 is placed in the placing grooves 34 of the posts 32 to be held on the boat 30. When the transfer arm 74a of the transfer robot 74 is returned into the transfer chamber 70 from the process chamber 16, the gate valve 62 is closed (substrate placing process).

In step 104 (S104), the process chamber 16 is under a N₂ atmosphere. Specifically, while the gas (atmosphere) in the process chamber 16 is exhausted through the gas exhausting parts 42, the N₂ gas is introduced into the process chamber 16 from the gas introduction part 40 as the introduced gas. After performing the process for a predetermined time, the exhausted and the introduction of the gas are stopped (substitution process).

In step 106 (S106), the wafer 14 is heated. The electromagnetic wave is generated by the electromagnetic wave generating part 20 and is introduced into the process chamber 16 from the waveguide port 24. In addition, a coolant is supplied to the cooling plate 54 to suppress the increase in the temperature of the wall surface 52. After introducing the electromagnetic wave for a predetermined time, the introduction of the electromagnetic wave is stopped (heating process).

In the heating process, when the temperature detector 26 detects that a temperature of the wafer 14 is higher than a predetermined temperature, the controller 80 opens the valves V1 and V2 to introduce the N₂ gas into the process chamber 16 from the gas introduction part 40 and to simultaneously exhaust the N₂ gas in the process chamber 16 through the gas exhausting part 42. Thereafter, the wafer 14 is cooled down to the predetermined temperature.

In step 108 (S108), the wafer 14 is unloaded from the process chamber 16. By a sequence in reverse to those described in the substrate loading process S100 and the substrate placing process S102, the wafer 13 subjected to the heating process is unloaded into the transfer chamber 70 from the process chamber 16, completing the operation of the substrate processing apparatus 10.

In accordance with the embodiment, while the gas exhausting parts 42 installed at four corners of the process chamber 16 have been described, the present invention is not limited thereto and at least two gas exhausting parts may be installed at symmetry positions of the wafer 14 held by the boat 30. In addition, since the plurality of gas exhausting parts 42 are installed at each corner of the upper portion of the process chamber 16 (for example, two gas exhausting parts are installed at each corner, and a total of eight gas exhausting parts are installed) to increase a exhauste amount.

The gas exhausting parts 42 may be installed at least over the wafer 14, and the gas exhausting parts 42 may be installed at side surfaces of the process chamber 16. The shape of the gas exhausting parts 42 may be not only a circular shape but an oval shape, a polygonal shape or a rod shape. In addition, the process chamber 16 is not limited to a cuboid shape and may have a sphere shape.

While the configuration wherein the coolant is supplied to the cooling plate 54 is described in accordance with the embodiment, the cooling structure is not limited thereto and may be an air cooling type or an electric element cooling type.

### Second Embodiment

Hereinafter, the second embodiment will be described.

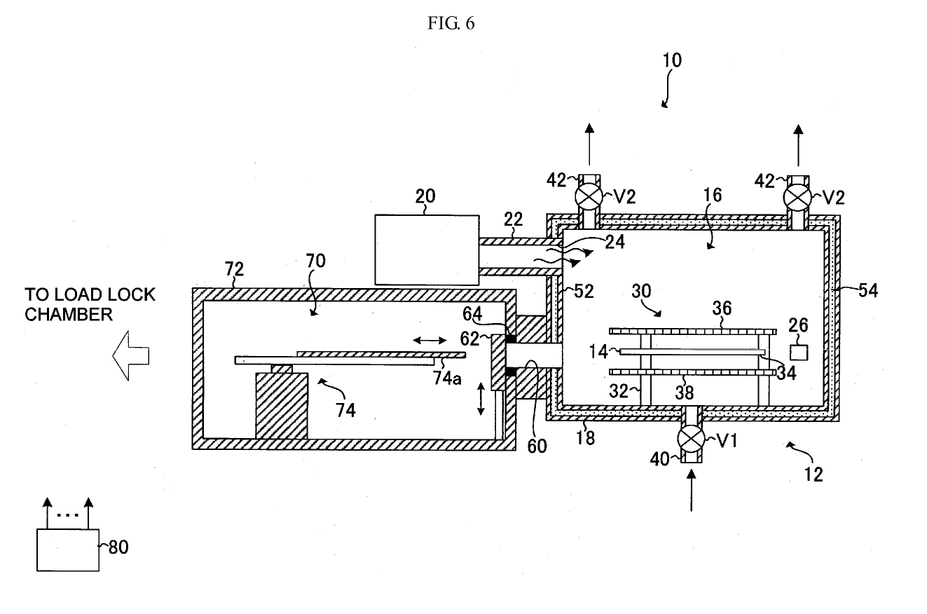

FIG. 6 is a cross-sectional view of an electromagnetic heating apparatus 12 in accordance with the second embodiment of the present invention. While the waveguide port 24 and the gate valve 62 are installed at different side surfaces of the process container 18 in accordance with the first embodiment, the waveguide port 24 and the gate valve 62 are installed at the same side surface of the process container 18 in accordance with of the second embodiment

By installing the waveguide port 24 at the same surface as the gate valve 62, an installation space can be saved. In addition, by employing a structure wherein a surface opposite to the surface having the waveguide port 24 and the gate valve 62 thereon can be completely detachable, a maintenance can be facilitated.

### Preferred Embodiment of the Invention

Hereinafter, the preferred embodiment of the present invention will be described.

According to an embodiment of the present invention, there is provided A substrate processing apparatus including: a process chamber for processing a substrate; a substrate holder installed in the process chamber to hold the substrate; a gas introduction part installed below the substrate held by the substrate holder for introducing a gas toward a back surface of the substrate; and an electromagnetic wave introduction part installed over the substrate held by the substrate holder for introducing an electromagnetic wave.

Preferably, the substrate holder includes a ring-shaped reflective part vertically overlapping an edge of the substrate held by the substrate holder and reflecting the electromagnetic wave.

Preferably, the apparatus further includes a gas exhausting part installed over the substrate held by the substrate processing apparatus for exhausting the gas.

Preferably, the gas exhausting part is installed so as not to vertically overlap the substrate held by the substrate holder.

Preferably, at least two of the gas exhausting parts are installed.

Preferably, the apparatus further includes a cooling part for cooling a wall surface of the process chamber.

According to another embodiment of the present invention, there is provided a substrate processing method including steps of: loading a substrate into a process chamber and holding the substrate using a substrate holder; introducing a gas into the process chamber from a gas introduction part installed below the substrate held by the substrate holder; exhausting the gas in the process chamber through a gas exhausting part installed over the substrate held by the substrate holder; and introducing an electromagnetic wave into the process chamber.

What is claimed is:

1. A substrate processing apparatus comprising:
a process chamber for processing a substrate;
a substrate holder installed in the process chamber to hold the substrate;
a gas introduction part installed below the substrate held by the substrate holder for introducing a gas toward a back surface of the substrate; and
an electromagnetic wave introduction part installed over the substrate held by the substrate holder for introducing an electromagnetic wave.

2. The substrate processing apparatus according to claim 1, wherein the substrate holder comprises a ring-shaped reflective part vertically overlapping an edge of the substrate held by the substrate holder and reflecting the electromagnetic wave.

3. The substrate processing apparatus according to claim 1, further comprising a gas exhausting part installed over the substrate held by the substrate processing apparatus for exhausting the gas.

4. The substrate processing apparatus according to claim 3, wherein the gas exhausting part is installed so as not to vertically overlap the substrate held by the substrate holder.

5. The substrate processing apparatus according to claim 3, wherein at least two of the gas exhausting part are installed.

6. The substrate processing apparatus according to claim 1, further comprising a cooling part for cooling a wall surface of the process chamber.
